(19) United States
(12) Patent Application Publication
(10) Pub. No.: US 2017/0015094 A1
(43) Pub. Date: Jan. 19, 2017

(54) METHOD FOR MANUFACTURING DESIGN-PRINTED MASK SHEET

(71) Applicant: SD BIOTECHNOLOGIES CO., LTD., Seoul (KR)

(72) Inventors: Sul Woong Park, Seoul (KR); Mi Hye Choi, Seoul (KR)

(73) Assignee: SD BIOTECHNOLOGIES CO., LTD.

(21) Appl. No.: 15/003,137

(22) Filed: Jan. 21, 2016

(30) Foreign Application Priority Data
Jan. 26, 2015 (KR) 10-2015-0011984
Oct. 7, 2015 (KR) 10-2015-0141100
Oct. 22, 2015 (JP) 2015-208191

(51) Int. Cl. B41F 5/24

(52) U.S. Cl. CPC B41F 5/24

(57) ABSTRACT

The present invention relates to a method for manufacturing a design-printed mask sheet and a mask sheet manufactured thereby. The present inventors developed a particular pattern-printed mask sheet by first applying the flexo printing to the manufacturing of mask sheets. The manufacturing method of the present invention makes it possible to print a mask with colors obtained from the mixing of various inks, and thus the mask has an aesthetic sense, unlike existing color or pattern-free mask sheets, and employs an eco-friendly aqueous or alcoholic solvent, thereby allowing the application to processing beauty products in various ways.

### CROSS-REFERENCE TO RELATED APPLICATIONS

This application claims the benefit and priority of Japanese Patent Application No. 2015-208191, filed Oct. 22, 2015, Korean Patent Application No. 10-2015-0141100, filed Oct. 7, 2015 and Korean Patent Application No. 10-2015-0011984, filed Jan. 26, 2015. The entire disclosure of the above applications is incorporated herein by references.

### FIELD

The present disclosure relates to a method for manufacturing a design-printed mask sheet and a mask sheet manufactured thereby.

### BACKGROUND

A general mask sheet is manufactured by cutting a non-woven fabric or a cotton fabric to an attachment part, packaging the cut fabric, adding a cosmetic composition into the packaged product, and sealing the resultant product. Since the mask sheet is directly attached to the body, a separate additive is generally not used in the manufacturing of the mask sheet itself.

Meanwhile, with respect to flexo printing (flexographic printing), a flexible and elastic rubber or resin plate is used as a press plate, and an organic solvent-based evaporative drying type ink, which contains water or alcohol as a main material, is used as a print ink. Flexo printing is characterized in that the duplication of plates is easy, a partial exchange is allowable, and post-processing/post-treatment processes (perforating, molding wax binding, iron core driving, etc.) can be sequentially performed. In addition, flexo printing is eco-friendly due to the use of an aqueous (water or alcohol) solvent.

The present inventors developed a particular pattern-printed mask sheet by applying the flexo printing to the manufacturing of mask sheets. That is, the mask sheet of the present invention is obtained by printing a pattern on a non-woven fabric, which is a raw material for the mask sheet, using flexo printing and a low-irritant ink. The mask sheet of the present invention has an aesthetic sense due to the printed pattern, unlike existing color or pattern-free mask sheets.

Throughout the entire specification, many papers and patent documents are referenced and their citations are represented. The disclosures of cited papers and patent documents are entirely incorporated by reference into the present specification, and the level of the technical field within which the present invention falls, as well as details of the present invention are explained more clearly.

### SUMMARY

The present inventors endeavored to develop a particular pattern-printed mask sheet. As a result, the present inventors developed a particular pattern-printed mask sheet by first applying flexo printing to the manufacturing of mask sheets. The present inventors confirmed that this technique makes it possible to print a mask with colors, which are obtained from the mixing of various inks, and thus the mask has an aesthetic sense, unlike existing color or pattern-free mask sheets, and this technique employs an eco-friendly aqueous (water or alcohol) solvent, and thus can be applied to the processing of beauty products in various ways, and then the present inventors completed the present invention.

An aspect of the present invention is to provide a method for manufacturing a design-printed mask sheet.

Another aspect of the present invention is to provide a mask sheet.

Other purposes and advantages of the present disclosure will become more obvious with the following detailed description of the invention, claims, and drawings.

### DETAILED DESCRIPTION

In accordance with an aspect of the present invention, there is provided a method for manufacturing a design-printed mask sheet, the method including:

(a) printing a pattern on a non-woven fabric using flexo printing; and

(b) cutting the non-woven fabric to the printed pattern.

The present inventors endeavored to develop a particular pattern-printed mask sheet. As a result, the present inventors developed a particular pattern-printed mask sheet by first applying flexo printing to the manufacturing of mask sheets. The present inventors confirmed that this technique makes it possible to print a mask with colors, which are obtained from the mixing of various inks, and thus the mask has an aesthetic sense, unlike existing color or pattern-free mask sheets, and this technique employs an eco-friendly aqueous (water or alcohol) solvent, and thus can be applied to the processing of beauty products in various ways.

The printing methods are classified into four types: offset printing; gravure printing; flexo printing; and screen printing. Of these, the off-set printing, the gravure printing, and the flexo printing are used for mass production. The off-set printing is mainly used for publications; the flexo printing is mainly used for pack paper; and the flexo printing is mainly used for paper box printing. The off-set printing has disadvantages in that, in spite of having abundant colors, an unstable color tone is shown due to the use of dampening water, and the printing machine is complicated. In the case of the gravure printing, toluene is used as a solvent, and thus a lot of time is spent drying printed materials, and the exposure to toluene for a long time may cause cancer. Therefore, the gravure printing is not suitable to print on articles in contact with the human body. In addition, the gravure printing is easily affected by the leveling of the paper surface, and has a longer plate-making process compared with the flexo printing. The flexo printing, which is rotary type embossing printing, has advantages in that faster drying is achieved compared with other printing methods, and components (alcohols, smells, etc.) harmful to the human body are evaporated quickly since alcohol type solvents are used and quickly dried. Thus, the present inventors used flexo printing, which is capable of achieving mass printing while having no influence on the human body.

Meanwhile, existing mask sheets were pattern-free sheets which were manufactured by only a simple cutting process. Based on this matter, the present inventors developed a method for manufacturing a novel type of mask sheet by printing a particular pattern on a mask sheet using flexo printing.

Hereinafter, the method for manufacturing a mask sheet of the present invention will be described:

Step (a): Printing Pattern on Non-Woven Fabric

First, a pattern is printed on a non-woven fabric using flexo printing.

Herein, the term “pattern” refers to a particular figure, which is expressed by color or shade and displayed as a two-dimensional design. The pattern may be expressed by various colors, and various known patterns may be shown. According to an embodiment of the present invention, the pattern is an animal pattern or an animal face pattern.

The flexo printing is a printing method in which a flexible rubber or resin plate is used as a press plate, and an organic solvent-based evaporative drying type ink, which contains water or alcohol as a main material, is used as a print ink (see FIGS. 1 and 2).

The flexo printing of the present invention may be conducted by including the following steps of:

i) attaching the non-woven fabric to an unwinder;

ii) putting a printing ink in a fountain roller;

iii) transferring the ink to an anilox roller made of a metal;

iv) printing the pattern on the non-woven fabric using a flexo graphic plate-fixed plate cylinder; and

v) fixing the non-woven fabric to the plate cylinder using an impression cylinder.

The flexo printing of the present invention may use an evaporative drying type ink, which is low irritant to the body and contains aqueous or alcoholic organic solvent as a main material. For example, the ink contains an evaporative organic solvent (e.g., alcohol, acetate, ether, ester, etc.), and may further contain a colorant, distilled water, a resin, and the like. The evaporative organic solvent may be contained in a content of 75-85 wt % on the basis of the entire ink composition.

According to an embodiment of the present invention, the ink may contain ethyl alcohol, ethyl acetate, an ether organic solvent, a colorant, and a resin. According to a particular embodiment of the present invention, the ink contains 30-35 wt % of ethyl alcohol, 10-15 wt % of ethyl acetate, 15-20 wt % of ether, 5-10 wt % of a colorant, and 10-15 wt % of a resin, on the basis of the entire ink composition.

The non-woven fabric of the present invention may use a mixed fabric of a wood pulp and a thermoplastic resin. As the thermoplastic resin used in the present invention, various thermoplastic resins that are known in the art may be used. Preferably, at least one thermoplastic resin is selected from the group consisting of polycarbonate-based resins, polystyrene-based resins, polyether-based resins, polysulfone-based resins, polyolefin-based resins, polyimide-based resins, fluoro-based resins, poly(meth)acrylate-based resins, polyacetal-based resins, polyamide-based resins, aromatic vinyl-based resins, acryl-butadiene-styrene copolymer resins, and polyvinylchloride-based resins. More preferably, polyethylene terephthalate (PET) or polyethylene terephthalate glycol (PETG), which is an eco-friendly synthetic resin, may be used. According to an embodiment of the present invention, the non-woven fabric is a mixed fabric of a wood pulp and polyethylene terephthalate.

The mixed percentages of the wood pulp and the thermoplastic resin are 30-70 wt % and 40-60 wt % or 45-55 wt %, respectively. According to an embodiment of the present invention, the mixed percentages are 47-53 wt %, respectively.

Step (b): Cutting Non-Woven Fabric

Then, the printed non-woven fabric is cut into a mask sheet with a printed size and pattern.

More specifically, the printed non-woven fabric is slated into an appropriate length, and then, for a perforation work, the resultant non-woven fabrics are arranged in 60 layers (plate-making work). The overlapping non-woven fabrics are fixed using pins (pin work), and then the non-woven fabrics are molded into mask sheets with a printed size and pattern.

According to an embodiment of the present invention, the method of the present invention may include, before step (b), performing a plate-making work of arranging and overlapping non-woven fabrics.

According to another aspect of the present invention, the present invention provides a mask sheet manufactured by the method for manufacturing a mask sheet.

Mask sheets for various uses, including a cosmetic mask sheet, may be manufactured. The mask sheets may be manufactured to have various shapes depending on the characteristics of attachment parts, such as a shape and flexure. For example, the mask sheet may be manufactured such that it can be attached to various parts, such as face, neck, abdomen, legs, back, shoulders, hands, and feet, but are not limited thereto.

Since the mask sheet of the present invention is manufactured by the method for manufacturing a design-printed mask of the present invention, the overlapping descriptions therebetween are omitted to avoid excessive complication of the specification due to repetitive descriptions thereof.

Features and advantages of the present invention are summarized as follows:

(a) The present invention is directed to a method for manufacturing a design-printed mask sheet and a mask sheet manufactured thereby.

(b) The present inventors developed a particular pattern-printed mask sheet by first applying the flexo printing to the manufacturing of mask sheets.

(c) The manufacturing method of the present invention makes it possible to print a mask with colors obtained from the mixing of various inks, and thus the mask has an aesthetic sense, unlike existing color or pattern-free mask sheets, and employs an eco-friendly aqueous (water or alcohol) solvent, thereby allowing the application to processing beauty products in various ways.

### BRIEF DESCRIPTION OF THE DRAWINGS

FIG. 1 shows a working process for a mask sheet of the present invention.

FIG. 2 schematically shows a flexo plate and a printing principle.

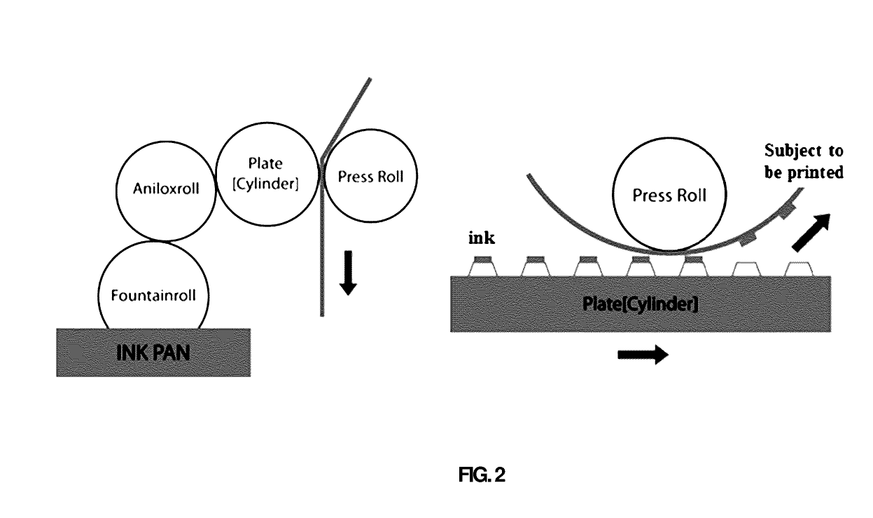

FIG. 3 schematically shows a device used in flexo printing.

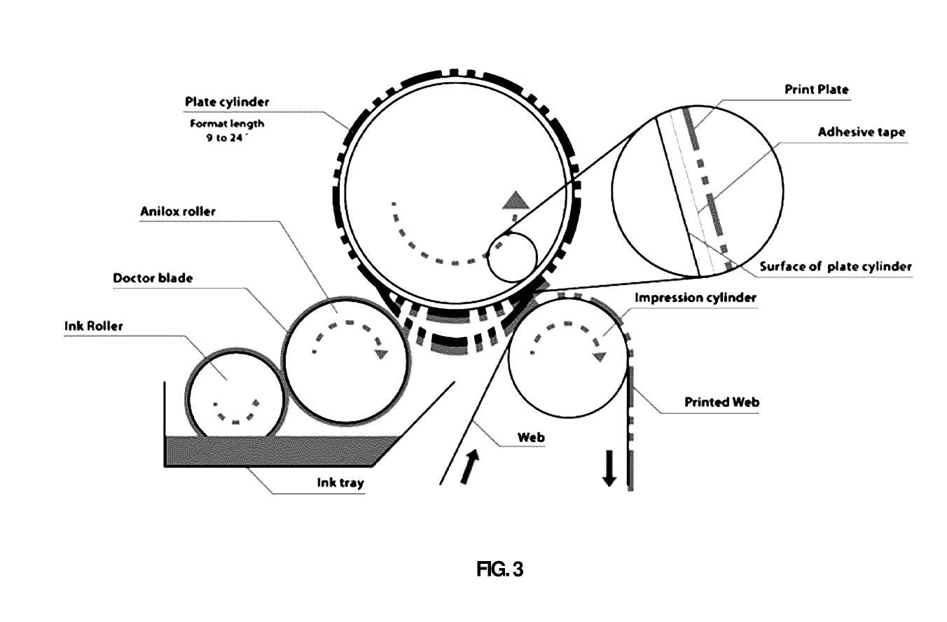

FIG. 4 schematically shows a work sequence for receiving a pack paper of non-woven fabric.

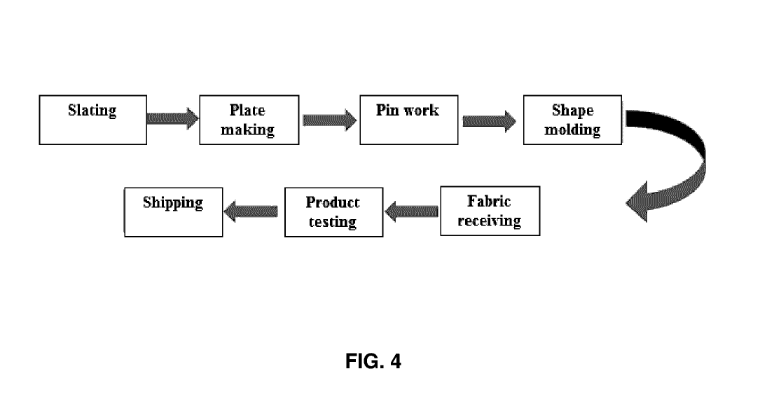

FIGS. 5a to 5d show examples of the mask sheet manufactured by the method of the present invention.

### EXAMPLES

Hereinafter, the present invention will be described in detail with reference to examples. These examples are only for illustrating the present invention more specifically, and it will be apparent to those skilled in the art that the scope of the present invention is not limited by these examples.

### Example 1

### Manufacturing Mask Sheet—Printing Non-Woven Fabric

First, a non-woven fabric suitable for a purpose (non-woven fabric for a mask sheet, P&T Inc.) was prepared, and then an animal pattern was printed on the cut mask sheet using flexo printing. In the printing, a rubber or resin was used for a letterpress plate of a flexible material, and an evaporative drying type ink, which contains an alcoholic organic solvent as a main material, is used as a print ink. Table 1 shows components of ink and contents thereof.

General properties of a flexo ink are as follows:

Appearance: Colored liquid

Viscosity: zahn cup#4—10-20 sec

Effluvium: Aqueous—ammonia odor, Oily—organic solvent-based odor

TABLE 1
Components of inks and contents thereof

| Component | Content (%) |
|---|---|
| Colorant | 5-10 |
| Resin | 10-15 |
| Ethyl alcohol | 30-35 |
| Ethyl acetate | 10-15 |
| Propylene glycol monomethyl ether | 15-20 |

The flexo printing is characterized in that the duplication of plates is easy; a partial exchange is allowable; post-processing/post-treatment processes (perforating, molding wax binding, iron core driving, etc.) can be sequentially performed; and printing is eco-friendly due to the use of an aqueous (water or alcohol) solvent.

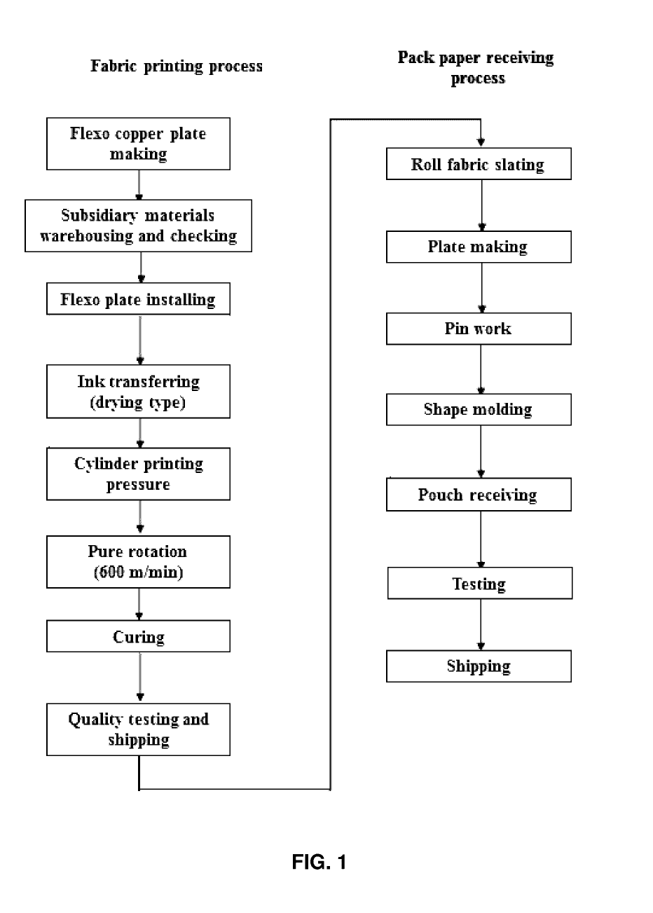

FIG. 1 shows a working process for manufacturing a mask sheet of the present invention, and the manufacturing procedure is as follows:

A. Preparing design for mask sheet to be manufactured, and performing plate-making work

B. Attaching resin plate to sleeve (according to printing colors)

C. Ink mixing and color mixing according to colors

D. Attaching fabric to unwinder

E. Focusing according to colors and checking pattern colors

F. Flexo printing

i) Put an ink in a fountain roller.

ii) Transfer the ink to an anilox roller made of a metal.

iii) Print the ink on a subject to be printed using a plate cylinder with a flexo graphic plate.

iv) Press the subject to be printed to the plate cylinder using an impression cylinder such that the subject is fixed to the plate cylinder.

G. Packaging and shipping according to rolls—Drying printed fabric and then packaging according to rolls

More detailed descriptions are as follows:

1. An embossed image is made on a smooth rubber plate, and the rubber plate is wound on a print plate cylinder.

2. A flexo ink, which is easily dried and forms a thin film on a material, such as plastic or foil, is supplied to an anilox roller.

3. The ink, which is cut in a doctor chamber to remain in a roller cup, is transferred to a resin plate.

4. The ink, which is put on an image of the resin plate, applies a kiss-touch degree of printing pressure on the fabric passing through an impression cylinder and a plate cylinder. Since the same amount of ink is transferred as long as the supply of the ink is not blocked, there are no differences in colors.

### Example 2

### Manufacturing Mask Sheet—Receiving Pack Paper of Non-Woven Fabric

The non-woven fabric of example 1 above is slated into an appropriate length. Then, for a perforation work, the resultant non-woven fabrics are allowed to overlap in 60 layers (plate-making work). The overlapping non-woven fabrics are fixed using pins (pin work), and then the non-woven fabrics are molded into mask sheets with a printed size and pattern.

### Example 3

### Skin Irritation Test of Mask Sheet (48 hrs Single Patch Test)

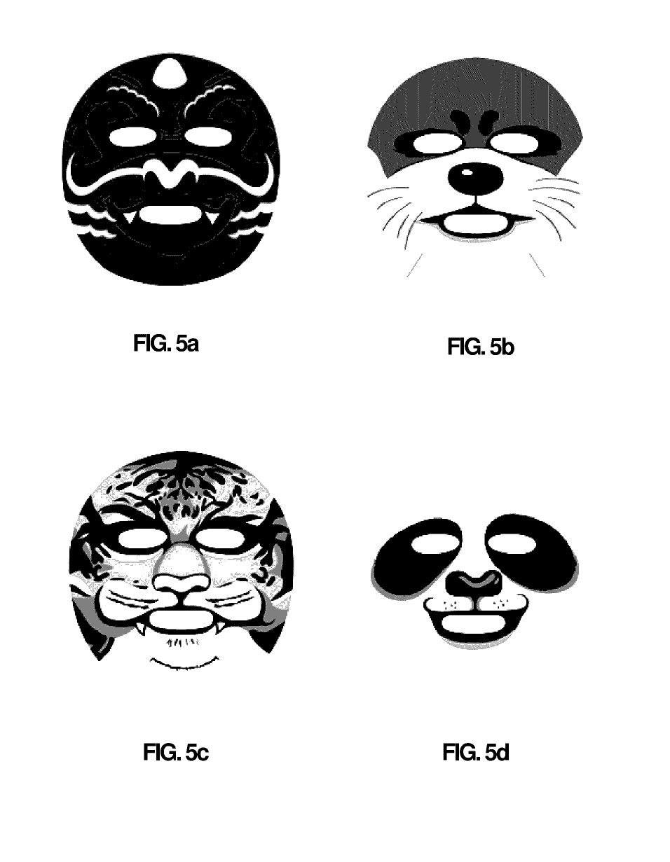

The skin irritation test was conducted on the mask sheets manufactured in examples 1 and 2. The presence or absence of primary irritation on human skin was checked on animal masks (FIGS. 5a to 5b) manufactured by the method of the present invention (testing institution: Dermapro Inc.).

The safety of skin external preparations including cosmetics, quasi-medicines, etc., is individually managed from used sources. However, it is likely that the respective sources interact with each other in the preparations, causing abnormal responses, and thus the safety test for final products is necessary. The human patch test is one of the most commonly used test methods. This test determines whether dermatitis occurs when a skin external preparation is contacted with the skin. A patch for patch testing is patched on an arm of a subject to observe a skin response with the naked eye. The test was performed on the subjects with normal skin, and experts evaluate responses shown as test results, such as erythema, edema, swelling, and papules, to determine the safety of the skin external preparation.

The present test was conducted on 30 healthy females or males of 18-60 years old without skin disorders. A test material is cut into 0.5×0.5 cm², attached on Finn Chambers®, put on a test part, such as a back, and then fixed by a micropore tape. The patching was conducted for 48 h, and the patches were removed, and then the test parts were marked using a skin marker. After 30 min and 24 h, the respective test parts were observed. The skin response was evaluated according to the reference that reflects the Frosch & Kligman method and the Personal Care Product Council (PCPC) guideline. Meanwhile, the average responses for 48 h and 72 h were calculated using the following equation, and the average response results for the respective materials were determined according to the reference of table 2.

$$Response = \frac{\sum ( Grade \times No . of Responders )}{4 ( Maximum grade ) \times n ( Total Subjects )} \times 100 \times 1 / 2$$

TABLE 2

| Response range | Standard |
|---|---|
| 0.00 ≦ R < 0.87 | Slight |
| 0.87 ≦ R < 2.42 | Mild |
| 2.42 ≦ R < 3.44 | Moderate |
| 3.44 ≦ R | Severe |

During the test period, the skin response was not observed in four types of present test products (table 3). As a result, the four types of present test products were determined to be a low-irritant range material in view of primary irritation of the human skin.

TABLE 3

| | | | | | Response grade |
|---|---|---|---|---|---|
| — | Test material | No. of responder | 48 hr | 72 hr | 48/72/mean |
| 1 | FIG. 5A | 0 | — | — | 0.0/0.0/0.0 |
| 2 | FIG. 5B | 0 | — | — | 0.0/0.0/0.0 |
| 3 | FIG. 5C | 0 | — | — | 0.0/0.0/0.0 |
| 4 | FIG. 5D | 0 | — | — | 0.0/0.0/0.0 |
| 5 | Negative control | 0 | — | — | 0.0/0.0/0.0 |

### Example 4

### Skin Toxicity Test of Mask Sheet

A skin toxicity test was performed on the mask sheets shown in FIG. 5c, which were manufactured in examples 1 and 2 (test institution: KOTITI testing & research institute). The contents of formaldehyde, an organic tin compound (tributyltin, TBT) and heavy metals in the mask sheet were evaluated.

As a result, formaldehyde was not detected (reference: less than 20 mg/kg), the organic tin compound TBT was not detected (reference: less than 0.1 mb/kg), and heavy metals (lead, chromium, barium, cadmium, arsenic, antimony, mercury, and selenium) were not detected (reference: lead, chromium, barium, cadmium, antimony, mercury, and selenium: less than 5 mg/kg; and arsenic: less than 2 mg/kg).

Although the present invention has been described in detail with reference to the specific features, it will be apparent to those skilled in the art that this description is only for a preferred embodiment and does not limit the scope of the present invention. Thus, the substantial scope of the present invention will be defined by the appended claims and equivalents thereof.

What is claimed is:

1. A method for manufacturing a design-printed mask sheet, the method comprising:
(a) printing a pattern on a non-woven fabric using flexo printing; and
(b) cutting the non-woven fabric to the printed pattern.

2. The method of claim 1, wherein step (a) comprises:
i) attaching the non-woven fabric to an unwinder;
ii) putting a printing ink in a fountain roller;
iii) transferring the ink to an anilox roller made of a metal;
iv) printing the pattern on the non-woven fabric using a flexo graphic plate-fixed plate cylinder; and
v) fixing the non-woven fabric to the plate cylinder using an impression cylinder.

3. The method of claim 1, further comprising, before step (b), performing a plate-making work of arranging and overlapping non-woven fabrics.

4. The method of claim 1, wherein an aqueous or alcoholic ink is used in the flexo printing.

5. The method of claim 1, wherein the non-woven fabric is a mixed fabric of a wood pulp and a thermoplastic resin.

6. A mask sheet, produced by a manufacturing method comprising:
(a) printing a pattern on a non-woven fabric using flexo printing; and
(b) cutting the non-woven fabric to the printed pattern.

7. The mask sheet of claim 6, wherein the mask sheet is a cosmetic mask sheet.
